(19) United States
(12) Patent Application Publication
(10) Pub. No.: US 2008/0010896 A1
(43) Pub. Date: Jan. 17, 2008

(54) Solar Powered Insect Trapping and Terminating Apparatus

(76) Inventor: Chin Kuo Lin, Sinjhuang City (TW)

Correspondence Address: HDSL, 4331 STEVENS BATTLE LANE, FAIRFAX, VA, 22033, US

(21) Appl. No.: 11/456,576

(22) Filed: Jul. 11, 2006

(51) Int. Cl. A01M 1/04

(52) U.S. Cl. 43/113

(57) ABSTRACT

A solar powered insect trapping and terminating apparatus includes an upper tube body, a lower tube body being disposed on the ground for the upper tube body to insert into the lower tube body and a case being disposed besides the lower tube body. A power supply is disposed within the case to implement the solar powered insect trapping and terminating apparatus. When a user tries to trap and terminate insects, he/she only needs to prepare a basin or to dig a sink on the ground, therefore, when the plurality of luminous elements of the lamp emitting light of different wavelengths, various kinds of insects would be attracted to fly to the basin or the sink then as an insect falls into the basin or the sink, it would be trapped inside and could not escape.

### BACKGROUND OF THE INVENTION

1. Field of the Invention

The present invention is related to a solar powered insect trapping and terminating apparatus, and more particularly, to a light source using a plurality of luminous elements to emit light of different wavelengths to attract insect based on the fact that insects are apt to be attracted to various light sources. Therefore, the light emitted by the plurality of luminous elements would attract insects to fly to the basin or sink disposed in advance, when an insect falls into the basin or sink, it would be trapped inside and could not escape.

2. Description of Related Art

Insects live among us, and some of them are harmful to humans. Among all, mosquito is commonly seen in the households. Mosquitoes are irritating because they would sting people. Besides, pest problems are troublesome to farmers who grow grain, flowers and fruits since pests would damage their crops. Therefore, farmers are also constantly seeking ways to terminate pests to protect their properties.

Basically, people often use so-called mosquito-killer lamps to catch mosquitoes. A mosquito-killer lamp exploits the characteristics that insects tend to fly towards light sources and are sensitive to specific wavelength, so when it is lightened up, mosquitoes would fly near and instantaneously get burned by the high voltage provided by the mesh of the mosquito-killer lamp; the same applies to the electric mosquito swatter. However, the mosquito-killer lamp is dangerous to seniors and children alike, because the elder could get cataract if he/she stares at the lamp too long, and the child could be electric shocked if he/she touches the mosquito-killer lamp out of curiosity. It is also expensive to turn on the mosquito-killer lamp for it would consume a lot of electric power. Furthermore, even though the electric mosquito swatter runs on batteries to save energy, a careless user would accidentally touch the net and get electric shocked.

Therefore, the above-mentioned traditional insect trapping and terminating apparatus presents several shortcomings to be overcome.

In view of the above-described deficiencies of traditional insect trapping and terminating apparatus, after years of constant effort in research, the inventor of this invention has consequently developed and proposed a solar powered insect trapping and terminating apparatus in the present invention.

### SUMMARY OF THE INVENTION

The present invention is to provide a solar powered insect trapping and terminating apparatus which attracts insects based on the fact that insects would be attracted to different light sources and uses a plurality of luminous elements having different wavelengths to emit light of different wavelengths, therefore, various kinds of insects would see the light and fly to the basin or the sink. When an insect falls into the basin or the sink, it would be trapped inside and could not escape.

Another, the present invention is to provide a power supply which stores electric power transformed by a solar module to act as a power source, therefore, the solar powered insect trapping and terminating apparatus is self-contained without requiring external power source.

Still another, the present invention is to provide a solar powered insect trapping and terminating apparatus which comprises a solar module that can swing according to the position where the sunlight shines upon.

Still another, the present invention is to provide a solar powered insect trapping and terminating apparatus which is low cost, easy to operate and simple in its structure.

The present invention discloses a solar powered insect trapping and terminating apparatus, comprising an upper tube body, a guiding board, a frame, a shaft, a lower tube body and a case; wherein the upper tube body having its upper end pivotally coupled to a semicircular guiding board, the guiding board connecting to a frame, and a solar module being disposed inside the frame; also a semicircular guiding trench being implemented on the guiding board, with a bolt implemented with a nut going through the guiding trench and being fixed to the upper end of the upper tube body for the frame to be guided by the guiding trench to move on a curve; a shaft being suitably locked to a side of the upper tube body, with a lamp connecting to a front end of the shaft, and a first circuit board being disposed inside the lamp, the first circuit board having a bottom connected to a plurality of luminous elements having different wavelengths; furthermore, a lower tube body being disposed on the ground for the upper tube body to insert into the lower tube body, the lower tube body having a side suitably implemented with an adjusting bolt, which can adjust a position where the upper tube body is fixed to the lower tube body, when the upper tube body has been moved to the position, the adjusting bolt is used to fix the upper tube body within the lower tube body; and a case being disposed besides the lower tube body, a power supply being disposed within the case and coupled with a second circuit board, and the second circuit being coupled with the first circuit board inside the lamp, then a control switch being coupled with the second circuit board and disposed at an outer surface of the case, thereby implementing the solar powered insect trapping and terminating apparatus; when a user tries to trap and terminate insects, he/she only needs to prepare a basin or to dig a sink on the ground, therefore, when the plurality of luminous elements of the lamp emitting light of different wavelengths, various kinds of insects would be attracted to fly to the basin or the sink, then as an insect falls into the basin or the sink, it would be trapped inside and could not escape.

These features and advantages of the present invention will be fully understood and appreciated from the following detailed description of the accompanying Drawings.

### BRIEF DESCRIPTION OF THE DRAWINGS

FIG. 1 illustrates a side view of a solar powered insect trapping and terminating apparatus in the present invention;

FIG. 2A and FIG. 2B illustrate how the frame of the solar powered insect trapping and terminating apparatus swings; and

FIG. 3 illustrates an embodiment of the solar powered insect trapping and terminating apparatus in the present invention.

### DETAILED DESCRIPTION OF THE PREFERRED EMBODIMENT

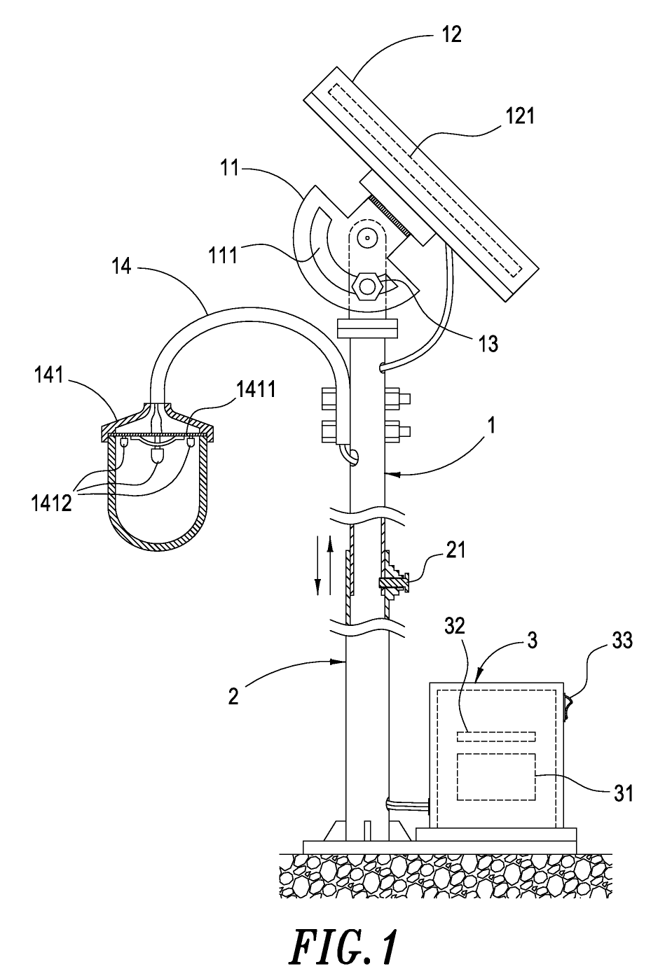

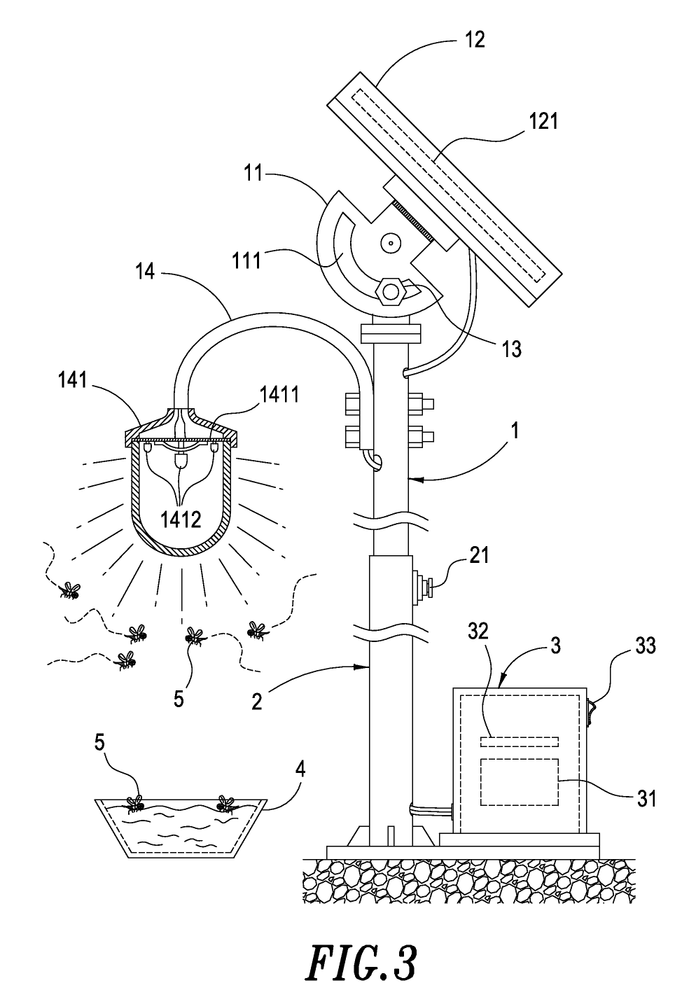

Please refer to FIG. 1 through FIG. 3 for a solar powered insect trapping and terminating apparatus disclosed in the present invention, which comprise a upper tube body 1, a lower tube body 2 and a case 3.

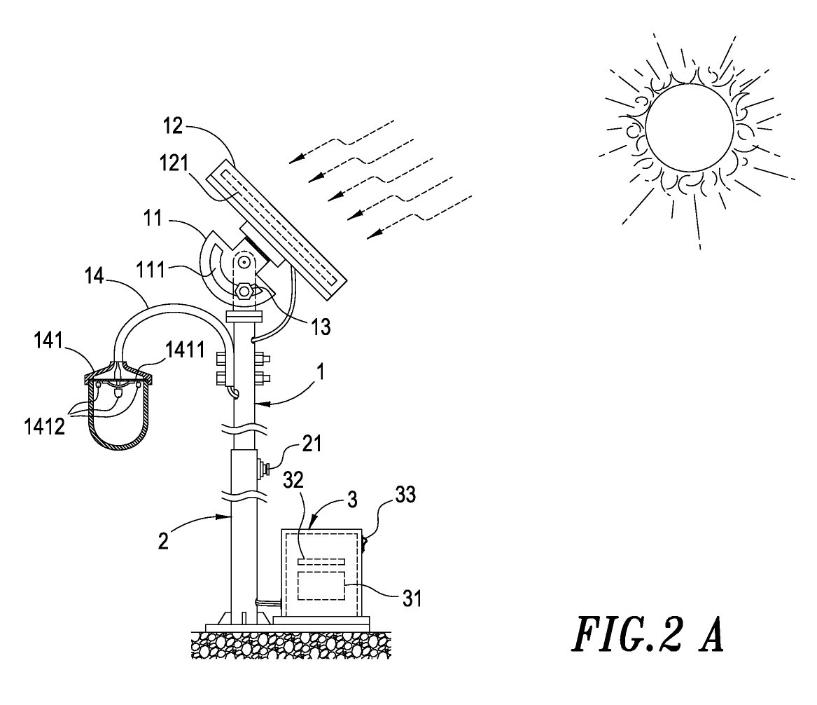

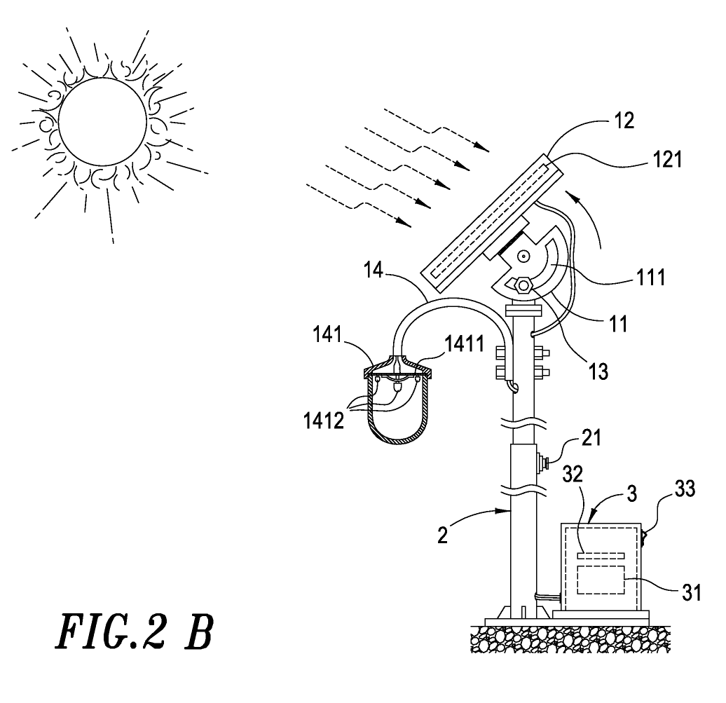

The upper tube body 1 has its upper end pivotally coupled to a semicircular guiding board 11, the guiding board 11 connecting to a frame 12, and a solar module 121 being disposed inside the frame 12. Also a semicircular guiding trench 111 is implemented on the guiding board 11, with a bolt 13 implemented with a nut going through the guiding trench 111 and fixed to the upper end of the upper tube body 1 for the frame 12 to be guided by the guiding trench 111 to move on a curve (as shown in FIG. 2A and FIG. 2B). A shaft 14 is suitably locked to a side of upper the tube body 1, with a lamp 141 connecting to a front end of the shaft 14, and a first circuit board 1411 is disposed inside the lamp 141. The first circuit board 1411 has a bottom connected to a plurality of luminous elements 1412 having different wavelengths. The solar module 121 is provided for receiving sunlight and transforming it into electric power

The lower tube body 2 is disposed on the ground for the upper tube body 1 to insert into the lower tube body 2. The lower tube body 2 has a side suitably implemented with an adjusting bolt 21, which can adjust a position where the upper tube body 1 is fixed to lower tube body 2. When the upper tube body 1 has been moved to the position, the adjusting bolt 21 is used to fix the upper tube body 1 within the lower tube body 2.

The case 3 has a power supply 31 disposed therein, the power supply 31 is coupled with a second circuit board 32, and the second circuit 32 is coupled with the first circuit board 1411 inside lamp 141, then a control switch 33 is coupled with the second circuit board 32 and disposed at an outer surface of the case 3. The power supply 31 stores electric power transformed by the solar module 121 to act as a power source. The power supply 31 is a battery or other devices capable of storing electric power. The control switch 32 controls the operations of the plurality of luminous elements 1412 inside lamp 141.

The solar powered insect trapping and terminating apparatus of the present invention is implemented by components disclosed above. When a user tries to trap and terminate insects, he/she only needs to prepare a basin or to dig a sink on the ground, therefore, when the plurality of luminous elements 1412 of lamp 141 emitting light of different wavelengths, various kinds of insects 5 would be attracted to fly to lamp 141 and fall into the basin or the sink, they would be trapped inside and could not escape, thereby carrying out the trapping and terminating functions.

The present invention provides a solar powered insect trapping and terminating apparatus, which compares with other traditional powered insect trapping and terminating devices, is advantageous in:

1. The present invention provides a solar powered insect trapping and terminating apparatus which attracts insects based on the fact that insects would be attracted to different light sources and uses a plurality of luminous elements having different wavelengths to emit light of different wavelengths, therefore, various kinds of insects would see the light and fly to the basin or the sink. When an insect falls into the basin or the sink, it would be trapped inside and could not escape.

2. The present invention provides a power supply which stores electric power transformed by a solar module to act as a power source, therefore, the solar powered insect trapping and terminating apparatus is self-contained without requiring external power source.

3. The present invention provides a solar powered insect trapping and terminating apparatus which comprises a solar module that can swing according to the position where the sunlight shines upon.

4. The present invention provides a solar powered insect trapping and terminating apparatus which is low cost, easy to operate and simple in its structure, making it easy to promote this product.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A solar powered insect trapping and terminating apparatus, comprising:
an upper tube body having an upper end pivotally coupled to a guiding board, the guiding board connecting to a frame, and a solar module being disposed inside the frame; also a guiding trench being implemented on the guiding board, with a bolt implemented with a nut going through the guiding trench and being fixed to the upper end of the upper tube body; a shaft being suitably locked to a side of the upper tube body, with a lamp connecting to a front end of the shaft, and a first circuit board being disposed inside the lamp, the first circuit board having a bottom connected to a plurality of luminous elements having different wavelengths;
a lower tube body being disposed on the ground for the upper tube body to insert into the lower tube body, the lower tube body having a side suitably implemented with an adjusting bolt to fix the upper tube body within the lower tube body; and
a case having a power supply being disposed within the case and coupled with a second circuit board, and the second circuit being coupled with the first circuit board inside the lamp, then a control switch being coupled with the second circuit board and disposed at an outer surface of the case.

2. The solar powered insect trapping and terminating apparatus of claim 1, wherein the frame is guided by the guiding trench of the guiding board to move on a curve.

3. The solar powered insect trapping and terminating apparatus of claim 1, wherein the solar module is provided for receiving sunlight and transforming it into electric power.

4. The solar powered insect trapping and terminating apparatus of claim 1, wherein the adjusting bolt adjusts a position where the upper tube body is fixed to the lower tube body, when the upper tube body has been moved to the position, the adjusting bolt is used to fix the upper tube body to the lower tube body.

5. The solar powered insect trapping and terminating apparatus of claim 1, wherein the power supply stores electric power transformed by the solar module to act as a power source.

6. The solar powered insect trapping and terminating apparatus of claim 1, wherein the power supply is a battery or other devices capable of storing electric power.

7. The solar powered insect trapping and terminating apparatus of claim 1, wherein the control switch controls an operation of the plurality of luminous elements inside the lamp.

8. The solar powered insect trapping and terminating apparatus of claim 1, wherein a basin or a sink can be disposed under the case in advance to cause an insect to fall into the basin or the sink.
